(19) United States
(12) Patent Application Publication
(10) Pub. No.: US 2017/0001609 A1
(43) Pub. Date: Jan. 5, 2017

(54) Actuation Device for a Parking Brake

(71) Applicant: Power-Cast Light Metal Solutions GmbH & Co. KG, Schlierbach (DE)

(72) Inventor: Wolfgang Kaltenmaier, Gruibingen (DE)

(73) Assignee: Power-Cast Light Metal Solutions GMBH & CO. KG, Schlierbach (DE)

(21) Appl. No.: 15/115,309

(22) PCT Filed: Jan. 30, 2015
(86) PCT No.: PCT/EP2015/051878

§ 371 Date: Jul. 29, 2016

(30) Foreign Application Priority Data
Feb. 21, 2014 (DE) 20 2014 100 779.2

(51) Int. Cl. B60T 7/10; G05G 1/04; G05G 5/24

(52) U.S. Cl. CPC B60T 7/105; G05G 5/24; G05G 1/04

(57) ABSTRACT

The invention relates to an actuation device (1) for a parking brake and is comprised of a parking brake lever (2) swivel-mounted on a bearing block (3) and a blocking device by means of which the parking brake lever (2) can be fixed in place in a swivel position on the bearing block (3). The blocking device has a locking segment (11) that is connected to the bearing block (3) and a pawl (12) mounted on the parking brake lever (2). The bearing block (3) and the locking segment (11) are designed to be one piece and are made of a die-cast part or an injection-molded part.

### CROSS REFERENCE TO RELATED APPLICATIONS

This application is the U.S. national stage of International Application No. PCT/EP2015/051878, filed on Jan. 30 , 2015. The international application claims the priority of DE 202014100779.2 filed on Feb. 21, 2014; all applications are incorporated by reference herein in their entirety.

### BACKGROUND

The invention relates to an actuation device for a parking brake in accordance with the preamble of claim 1.

An actuation device of that type is comprised of a parking brake lever that is swivel-mounted on a bearing block. An actuation rod is held in the parking brake lever that can be actuated with a button and that is coupled to a blocking device. The blocking device serves to fix the parking brake lever in place in a specific swivel position. The blocking device can be released by pressing the button, and the parking brake lever can be put into a different swivel position in which it can once again be fixed in place by the blocking device.

The blocking device has a pawl and a locking segment. The locking segment is fastened to the bearing block and has an edge with teeth. The pawl has a detent lug on its lower end that can engage with the teeth of the locking segment. The upper end of the pawl is coupled to the actuation rod.

The pawl and the locking segment are typically made of stamped steel parts. The pawl is manufactured via a first stamping tool. A multitude of pawls are stamped out of a first raw material, especially out of a first steel band, with the stamping tool. The locking segment is manufactured analogously with a second stamping tool. A multitude of locking segments are stamped out of a second raw material, especially out of a second steel band, with this stamping tool.

A manufacturing process is known from DE 20 2009 005 532 U1 in which the pawl and the locking segment are stamped out of only one raw material, meaning a steel band; it is especially advantageous when the pawl is stamped out of the locking segment, which brings about efficient use of the raw material.

A drawback with regard to locking segments and pawls stamped in that way out of steel bands is that the stamping can only be carried out with limited precision; the profiles of the teeth on the locking segment and on the pawl can only be produced with limited precision because of that.

A further drawback is that the steel bands that the pawls and the locking segment are stamped out of are very thin. The locking segment, the pawl and their teeth are correspondingly narrow as a consequence, which frequently interferes with the quality of the locking connection between the locking segment and the pawl in an undesirable way.

A final drawback is that both the pawl and the locking segment have to be manufactured as separate parts and then fastened with separate fasteners to the bearing block or to the parking brake lever, as the case may be, which undesirably increases the manufacturing expense for the actuation device.

### SUMMARY

The invention relates to an actuation device (1) for a parking brake and is comprised of a parking brake lever (2) swivel-mounted on a bearing block (3) and a blocking device by means of which the parking brake lever (2) can be fixed in place in a swivel position on the bearing block (3). The blocking device has a locking segment (11) that is connected to the bearing block (3) and a pawl (12) mounted on the parking brake lever (2). The bearing block (3) and the locking segment (11) are designed to be one piece and are made of a die-cast part or an injection-molded part.

### DETAILED DESCRIPTION

The invention is based on the objective of providing an actuation device of the type mentioned at the outset that has an increased level of functionality with low construction expenses.

The elements of claim 1 are specified to solve this problem. Advantageous embodiments and useful design developments of the invention are described in the sub-claims.

The invention relates to an actuation device for a parking brake and is comprised of a parking brake lever swivel-mounted on a bearing block and a blocking device by means of which the parking brake lever can be fixed in place in a swivel position on the bearing block. The blocking device has a locking segment that is connected to the bearing block and a pawl mounted on the parking brake lever. The bearing block and the locking segment are designed to be one piece and are made of a die-cast part or an injection-molded part.

The locking segment can be manufactured with the bearing block in one production process because of the one-piece design of the locking segment with the bearing block. Since separate manufacturing processes are consequently no longer required for the locking segment, the construction expenses to manufacture the actuation device are substantially reduced.

A further advantage of the invention is that separate parts or devices for fastening the locking segment to the bearing block are no longer required, because the locking segment is now an integral part of the bearing block. This also leads to a reduction in the construction expense of the actuation device and, in particular, to substantially shortened assembly times.

The bearing block with the integrated locking segment is made of a die-cast part or an injection-molded part as per the invention. The die-cast part is generally comprised of a metallic material and is advantageously made of magnesium or aluminum. The injection-molded part is preferably made of plastic. Die-cast parts or injection-molded parts of that type are not just able to be manufactured in an efficient way. Rather, it is also advantageous that the die-cast part or the injection-molded part is reproducible and can be manufactured with a high level of precision. The teeth of the locking segment can therefore also be manufactured with a high level of precision, in particular; moreover, the geometries of the teeth can be freely specified. This manufacturing precision of the teeth of the locking segment leads to an improved, reproducible hold of the pawl in an arbitrary position on the teeth of the locking segment. This advantage is also reinforced by the fact that the geometry of the entire body of the locking segment can be freely specified in the manufacturing process of the die-cast part or the injection-molded part. The width of the locking segment can be freely specified here; in particular, the locking segment can have substantially wider dimensions than those that are possible in known locking segments that are stamped out of steel bands. The hold of the pawl on the locking segment is further improved because of the increased width of the locking segment.

The pawl allocated to the locking segment can be made of a metallic material here, in particular aluminum or magnesium. It is, advantageously, also possible to make the pawl out of plastic, especially in the form of a plastic injection-molded part that can be economically manufactured, on the one hand, and also manufactured in a highly precise way, on the other hand, because of the free shaping possibilities of the locking segment designed as a part of the bearing block.

The pawl can have several ratchet teeth, in particular when the pawl moves towards the locking segment or away from the locking segment with linear positioning movements.

Because of the design of the locking segment as part of a die-cast part, its geometry can be variably adapted to the respective installation situation and, in particular, to the geometry of the bearing block and the allocated parking brake lever with the pawl.

In so doing, the locking segment can have external teeth on a convex surface in a conventional manner.

Alternatively, the locking segment can have teeth whose geometries can be specified via the die-cast part.

### BRIEF DESCRIPTION OF THE DRAWINGS

The invention will be illustrated with the aid of the drawings below. The following are shown in the figures:

FIG. 1: Example of the actuation device for a parking brake as per the invention.

FIG. 2: Sectional view of the locking segment of the actuation device in accordance with FIG. 1.

FIG. 3: Alternative embodiment of the locking segment for the actuation device in accordance with FIG. 1.

FIG. 4: Individual diagram of a pawl for the actuation device in accordance with FIG. 1.

### DETAILED DESCRIPTION OF THE PREFERRED EMBODIMENTS

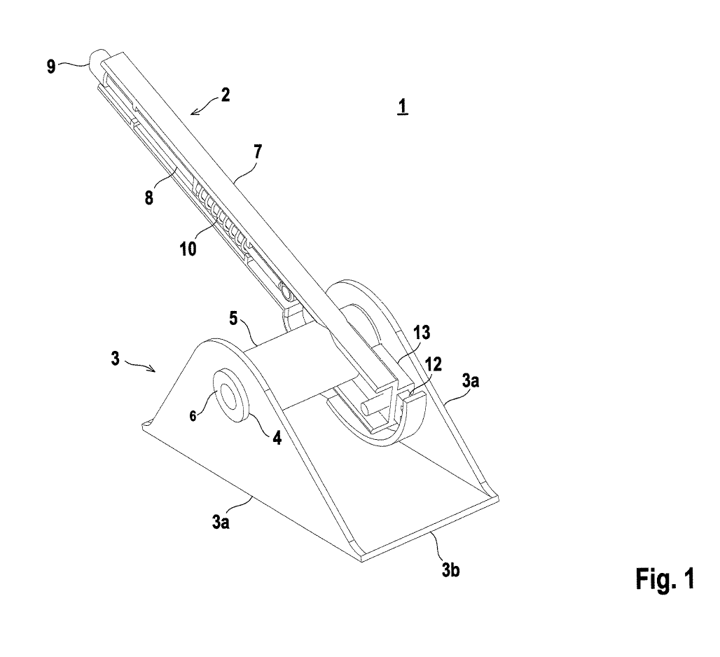

FIG. 1 schematically shows an example of the actuation device 1 as per the invention for a parking brake of a motor vehicle.

The actuation device 1 is comprised of a parking brake lever 2 and a bearing block 3. The parking brake lever 2 is swivel-mounted around a horizontal axis on the bearing block 3. The bearing block 3 is comprised of two flanks 3a with identical designs and a base piece 3b. The identically designed flanks 3a run in parallel and at a distance to one another. The flanks 3a project at a right angle from the base piece 3b in each case and are designed to be one piece with it. Each flank 3a has a hole 4 to form the swivel bearing. The identically designed holes 4 are opposite one another. Furthermore, the parking brake lever 2 has a tube-shaped receptacle 5 to form the swivel bearing. The parking brake lever 2 is swivel-mounted on the bearing block 3 via a shaft 6 or the like that is routed through the holes 4 on the bearing block 3 and the tube-shaped receptacle 5.

The respective swivel position of the parking brake lever 2 is transferred via a pull rod or the like, which is not shown, to the parking brake, likewise not shown, of the motor vehicle in which the actuation device 1 is installed.

The parking brake lever 2 has a rod-shaped base body 7 that is designed to be one piece with the tube-shaped receptacle 5 or that is at least connected to it in a fixed way. The base body 7 is formed by a laterally open profile in this case. An actuation rod 8 is mounted in the elongated front area of the base body 7 that projects over the bearing block 3. A button 9 projecting over the front end of the base body 7 is mounted on the front end of the actuation rod 8. The actuation rod 8 can be moved in an axial direction by actuating the button 9 against the spring force of a spring 10 that is mounted in the base body 7 and that surrounds the actuation rod 8. As soon as the button 9 is released, the actuation rod 8 is moved back again into its starting position by the spring force of the spring 10.

The parking brake lever 2, in particular its base body 7, is covered when fully assembled with a lining, not shown, whose front portion forms a handle; an operator grips the parking brake lever 2 with this to swivel it.

A blocking device is provided to fix the parking brake lever 2 in place in a specific swivel position. The blocking device is comprised of a locking segment 11 on the bearing block 3 and a pawl 12 on the parking brake lever 2.

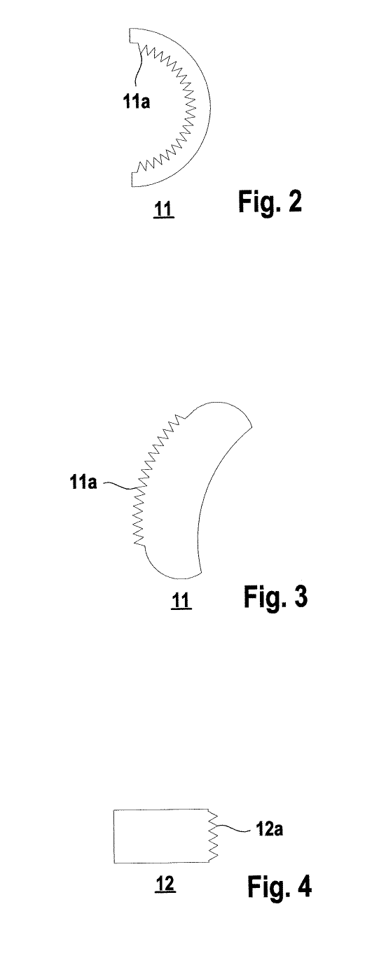

FIGS. 2 and 3 show two variants of a locking segment 11 in an individual diagram. FIG. 4 shows the pawl 12 in an individual diagram.

The pawl 12 is comprised in the instant case of a plastic injection-molded part. The pawl 12 has several ratchet teeth 12a (FIG. 4a) on its front edge that is turned towards the locking segment 11. The pawl 12 is mounted so as to be movable in the axial direction in a receptacle 13 that is a component of the parking brake lever 2 and that is laterally connected to its base body 7. The direction of motion of the pawl 12 runs in parallel with the direction of motion of the actuation rod 8. The pawl 12 is connected to the actuation rod 8 via a coupling element that is not separately shown. When the button 9 is pressed by an operator, the pawl 12 is inserted into the receptacle 5 because of the excursion of the actuation rod 8 caused by that. If the operator releases the button 9, the pawl 12 is pushed out of the receptacle 5 again via the return movement of the actuation rod 8.

The locking segment 11 has a one-piece design with the bearing block 3 as per the invention. The bearing block 3 with the locking segment 11 is comprised of one die-cast part that is made of magnesium in this case. In general, the die-cast part can also be made of a different metallic material such as aluminum. Furthermore, the bearing block 3 with the locking segment 11 could also be made of a plastic injection-molded part.

The locking segment 11 is arranged on the inside surface of a flank 3a of the bearing block 3 and, in fact, to the effect that the locking segment 11 is opposite the pawl 12 at a short distance.

As seen in FIG. 1 and the accompanying section view of FIG. 2, the locking segment 11 has inner teeth on a concave, circular-cylindrical surface on the inside surface of the locking segment 11 that is turned towards the pawl 12. The external surface of the locking segment 11 is also formed by a section of a circular-cylindrical surface. The toothing has a regular arrangement of identically designed teeth 11a that extend over the entire length of the locking segment 11.

FIG. 3 shows an alternative design form of the locking segment 11. External teeth are provided there, meaning that the teeth 11a are located on a convex surface of the locking segment 11 here.

In general, the geometries of the teeth 11a of the locking segment 11 can be precisely specified with the manufacturing process of the die-cast part, meaning that rework of the teeth 11a is not required.

The overall geometry of the locking segment 11 can also be precisely specified in the manufacturing process of the die-cast part; the geometry of the locking segment 11 can be freely chosen in broad areas. In particular, as FIG. 1 shows, the width of the locking segment 11 can be chosen to be substantially greater than the width of the pawl 12; an especially good hold of the pawl 12 on the locking segment 11 is ensured because of that.

The blocking device of the actuation device 1 in accordance with FIG. 1 operates in such a way that when the button 9 is not actuated, the actuation rod 8 exerts a force via the spring 10 on the pawl 12 so that it is pushed out of the receptacle 5 and pressed with contact pressure against the locking segment 11, so the ratchet teeth 12a of the pawl 12 engage with the teeth 11a of a partial area of the toothing of the locking segment 11. The parking brake lever 2 is fixed in place in a swivel position on the bearing block 3 because of that. It is important, when the pawl 12 is pressed against the locking segment 11, that the pawl 12 is guided with a linear movement against the locking segment 11. It is therefore possible to equip the pawl 12 with several ratchet teeth 12a; the hold of the pawl 12 on the locking segment 11 is improved because of that.

If the blocking device is to be released so that the parking brake lever 2 can be put into a different swivel position, an operator presses the button 9. The movement of the actuation rod 8 caused by that is converted via the coupling element into a movement of the pawl 12 to the effect that this pawl 12 is moved into the receptacle 5 and the ratchet teeth 12a of the pawl 12 are consequently no longer engaged with the teeth 11a of the locking segment 11. The operator can then swivel the parking brake lever 2 into the new desired swivel position. After that, the operator releases the button 9. The actuation rod 8 is moved into its starting position by the spring force of the spring 10 because of that, causing the pawl 12 to be moved against the locking segment 11 so that the ratchet teeth 12a of the pawl 12 are pressed with contact pressure against the teeth 11a of a new partial area of the toothing. The new swivel position of the parking brake lever 2 is thereby fixed in place.

The parking brake can be released by putting the parking brake lever 2 into a swivel position constituting a neutral position. The parking brake can be tightened, meaning actuated, by swiveling the parking brake lever 2 into a swivel position that is preferably above the neutral position.

### LIST OF REFERENCE NUMERALS

(1) Actuation device
(2) Parking brake lever
(3) Bearing block
(3a) Flank
(3b) Base piece
(4) Hole
(5) Receptacle
(6) Shaft
(7) Base body
(8) Actuation rod
(9) Button
(10) Spring
(11) Locking segment
(11a) Teeth
(12) Pawl
(12a) Ratchet teeth
(13) Receptacle

1. Actuation device (1) for a parking brake with a parking brake lever (2) swivel-mounted on a bearing block (3) and with a blocking device via which the parking brake lever (2) can be fixed in place in a swivel position on the bearing block (3), wherein the blocking device has a locking segment (11) connected to the bearing block (3) and a pawl (12) mounted on the parking brake lever (2), characterized in that the bearing block (3) and the locking segment (11) are designed to be one piece and are made of a die-cast part or an injection-molded part.

2. Actuation device according to claim 1, characterized in that the die-cast part forming the bearing block (3) and the locking segment (11) is made of magnesium or aluminum.

3. Actuation device according to claim 1, characterized in that the injection-molded part forming the bearing block (3) and the locking segment (11) is made of plastic.

4. Actuation device according to claim 1, characterized in that the width of the locking segment (11) can be freely specified.

5. Actuation device according to claim 1, characterized in that the locking segment (11) has teeth (11a) whose geometries can be specified via the die-cast part or the injection-molded part.

6. Actuation device according to claim 5, characterized in that the locking segment (11) has external teeth on a convex surface.

7. Actuation device according to claim 5, characterized in that the locking segment (11) has internal teeth on a concave surface.

8. Actuation device according to claim 1, characterized in that the pawl (12) is made of a metallic material.

9. Actuation device according to claim 8, characterized in that the pawl (12) is made of aluminum or magnesium.

10. Actuation device according to claim 1, characterized in that the pawl (12) is made of plastic.

11. Actuation device according to claim 1, characterized in that the pawl (12) is moved towards the locking segment (11) or away from it with linear positioning movements.

12. Actuation device according to claim 11, characterized in that the pawl (12) has several ratchet teeth (12a).
